(19) United States
(12) Patent Application Publication
(10) Pub. No.: US 2024/0386784 A1
(43) Pub. Date: Nov. 21, 2024

(54) COMMODITY REGISTRATION SYSTEM

(71) Applicant: Toshiba Tec Kabushiki Kaisha, Tokyo (JP)

(72) Inventor: Yuta SASAKI, Izunokuni Shizuoka (JP)

(21) Appl. No.: 18/590,838

(22) Filed: Feb. 28, 2024

(30) Foreign Application Priority Data
May 19, 2023 (JP) 2023-083468

(51) Int. Cl. G07G 1/00; G07G 1/12

(52) U.S. Cl. CPC G07G 1/0045; G07G 1/0018; G07G 1/12

(57) ABSTRACT

A commodity registration system comprises a camera and a commodity registration device including a processor configured to: acquire images of a commodity being placed in a housing unit from the camera; determine, based on at least one of the acquired images, commodity type identifications for the commodity; and when the commodity type identifications are different: store each of the commodity type identifications in second registration information, the second registration information identifying candidates for commodities to be purchased; and in response to a user selection of one of the commodity type identifications stored in the second registration information, store the selected commodity type identification in first registration information, the first registration information identifying commodities to be purchased.

### CROSS-REFERENCE TO RELATED APPLICATION

This application is based upon and claims the benefit of priority from Japanese Patent Application No. 2023-083468, filed May 19, 2023, the entire contents of which are incorporated herein by reference.

### FIELD

Embodiments described herein relate to a commodity registration system.

### BACKGROUND

In the related art, there is a technique in which an imaging device is provided in a shopping cart or a basket (hereinafter also referred to as a housing unit) to be used in a store, and a commodity stored in the housing unit is recognized from an image captured by the imaging device. In such a technique, when a customer performs an operation of placing a commodity in the housing unit, the commodity is registered as a purchase target, such commodity also referred to herein as a “registered commodity.”

However, in the above-described technique, even when photographing the same commodity, a recognition result for that commodity may vary depending on which imaging device and recognition method are used. For example, when a plurality of imaging devices are used, recognition results may be different for each imaging device because the angles for capturing images of a commodity are different. In this case, a photographed commodity cannot be identified, and the customer cannot register a new commodity until first checking the commodity stored in the housing unit.

### DESCRIPTION OF THE DRAWINGS

FIG. 1 is a diagram showing an example of a schematic configuration of a system according to an embodiment.

FIG. 2 is a side view showing an example of a schematic configuration of a shopping cart.

FIG. 3 is a diagram showing an example of a hardware configuration of a tablet terminal.

FIG. 4 is a diagram showing an example of a data configuration of a commodity master.

FIG. 5 is a diagram showing an example of a data configuration of a sales registration table.

FIG. 6 is a diagram showing an example of a data configuration of a candidate commodity table.

FIG. 7 is a diagram showing an example of a functional configuration of the tablet terminal.

FIG. 8 is a diagram showing an example of a screen displayed on the tablet terminal.

FIG. 9 is a diagram showing an example of a screen displayed on the tablet terminal.

FIG. 10 is a diagram showing an example of a screen displayed on the tablet terminal.

FIG. 11 is a diagram showing an example of a screen displayed on the tablet terminal.

FIG. 12 is a flowchart showing an example of commodity registration processing performed by the tablet terminal.

FIG. 13 is a flowchart showing an example of candidate commodity selection processing performed by the tablet terminal.

### DETAILED DESCRIPTION

In general, according to one embodiment, a commodity registration system that can efficiently register a commodity that is a purchase target is provided.

According to one embodiment, a commodity registration system includes a camera and a commodity registration device including a processor. The processor of the commodity registration device is configured to: acquire images of a commodity being placed in a housing unit from the camera; determine, based on at least one of the acquired images, commodity type identifications for the commodity; and when the commodity type identifications are different: store each of the commodity type identifications in second registration information, the second registration information identifying candidates for commodities to be purchased; and in response to a user selection of one of the commodity type identifications stored in the second registration information, store the selected commodity type identification in first registration information, the first registration information identifying commodities to be purchased.

Hereinafter, a commodity registration system according to an example embodiment will be described with reference to the accompanying drawings. A terminal device (hereinafter, also referred to as a tablet terminal) attached to a commodity transporting cart (hereinafter, also referred to as a shopping cart), used in a store, is described as an example of a commodity registration device. The disclosure is not limited to the application example.

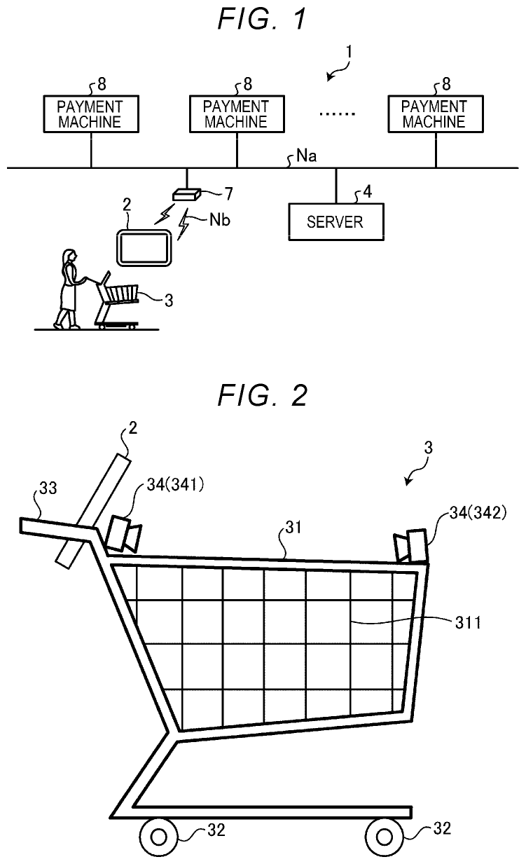

FIG. 1 is a diagram showing an example of a schematic configuration of a system 1 according to the embodiment. The system 1 is an example of a commodity registration system, and as shown in FIG. 1, the system 1 includes a tablet terminal 2, a server 4, and payment machines 8. The server 4 and the payment machines 8 are communicably connected to each other via a network Na.

As the network Na, the Internet, a virtual private network (VPN), a local area network (LAN), a public communication network, a mobile communication network, or the like can be used alone or in combination as appropriate. For example, the Internet and a mobile communication network may be used in combination as the network Na.

A wireless access point 7 is connected to the network Na. The wireless access point 7 is connected to the tablet terminal 2 via a network Nb such as a wireless LAN. Therefore, the tablet terminal 2 can communicate with the server 4 and the payment machines 8.

The shopping cart 3 includes a housing unit 31 (see FIG. 2) that houses a commodity displayed in a store. An upper portion of the housing unit 31 is open, and the commodity is placed in the housing unit 31 from above. A customer borrows the shopping cart 3 in the store, and places, in the housing unit 31, a commodity to be purchased from among displayed commodities while walking around the store together with the shopping cart 3.

The tablet terminal 2 is detachably provided in the shopping cart 3. The tablet terminal 2 recognizes a commodity to be placed in the housing unit 31 from an image captured by imaging units 34 which will be described later, and executes sales registration processing related to the commodity. Here, the sales registration processing means processing for setting, as a purchase target, a commodity specified by the tablet terminal 2. Specifically, the sales registration processing refers to processing of registration information for the recognized commodity (hereinafter, also referred to as sales registration data) in a sales registration table 242 which will be described later. For example, sales registration data is stored in the sales registration table 242 in the sales registration processing. The sales registration data includes a commodity code by which an item or the like of a commodity can be identified or the quantity of commodities to be purchased.

When receiving an operation for the customer to perform payment with one of the payment machines 8, the tablet terminal 2 executes processing for transferring the sales registration data for one transaction to the payment machine 8. For example, the tablet terminal 2 may encode the sales registration data in a code symbol such as a two-dimensional code and displays the code symbol. In this case, the payment machine 8 acquires the sales registration data for one transaction from the tablet terminal 2 by reading the code symbol displayed on the tablet terminal 2, and executes payment processing based on the sales registration data.

The server 4 performs information processing for performing a transaction for commodities in a store where the tablet terminal 2 is used. The server 4 may be, for example, a store server provided in a store or a server device provided outside the store. In the present embodiment, the server 4 may be a single device such as a cloud server or may be a plurality of devices such as those of a cloud system, connected to each other via a network.

The server 4 is a computer(s) that include(s) a processor, a main storage device, an auxiliary storage device, and the like. The server 4 stores, for example, a commodity master in which a commodity name, a price, and the like of a commodity to be sold in a store, in a database or the like, and provides the commodity master to the tablet terminal 2 or one of the payment machines 8.

Each of the payment machines 8 is a payment device provided in the store. The payment machine 8 executes settlement processing for a commodity based on the sales registration data. The settlement processing refers to processing of calculating and displaying change based on a total price and a tax amount of commodities related to one transaction, and a payment received from a customer, processing of dispensing a receipt on which commodity information and settlement information (total amount, payment amount, change amount, and the like) are printed, and the like.

Next, the shopping cart 3 will be described. FIG. 2 is a side view showing an example of a schematic configuration of the shopping cart 3. The shopping cart 3 includes the cage-shaped housing unit 31 having an open upper surface, wheels 32 disposed below the housing unit 31, and a handle unit 33 coupled to the housing unit 31 and the wheels 32 and gripped by a customer when the shopping cart 3 is moved.

The housing unit 31 has a configuration in which side surface portions and a bottom surface portion are surrounded by a mesh-shaped lattice 311 in a substantially quadrangular shape. A commodity housed in the housing unit 31 can be viewed from the outside. The side surface portions and the bottom surface portion may be formed by a wall surface instead of the mesh grid 311.

The shopping cart 3 further detachably includes the tablet terminal 2 in a vicinity of the handle unit 33. The shopping cart 3 includes a plurality of imaging units 34 (341 and 342) at the edges of an opening of the housing unit 31. The imaging units 34 are an example of an imaging unit, and are implemented as digital cameras or the like. FIG. 2 shows an example in which two imaging units 341 and 342 are provided, and the number of imaging units is not limited thereto. Three or more imaging units may be provided. Hereinafter, when the imaging units 341 and 342 are not distinguished from each other, the imaging units 341 and 342 are described as the imaging units 34.

The imaging units 34 are provided at different positions at which images of a commodity to be housed in the housing unit 31 can be captured. For example, an imaging direction of each imaging unit 34 is set such that at least a part of an imaging area thereof includes an inside of the housing unit 31. Each imaging unit 34 captures an image of a commodity to be housed in the housing unit 31 and outputs the captured image to the tablet terminal 2. Here, an image means a still image or a video with a plurality of frames.

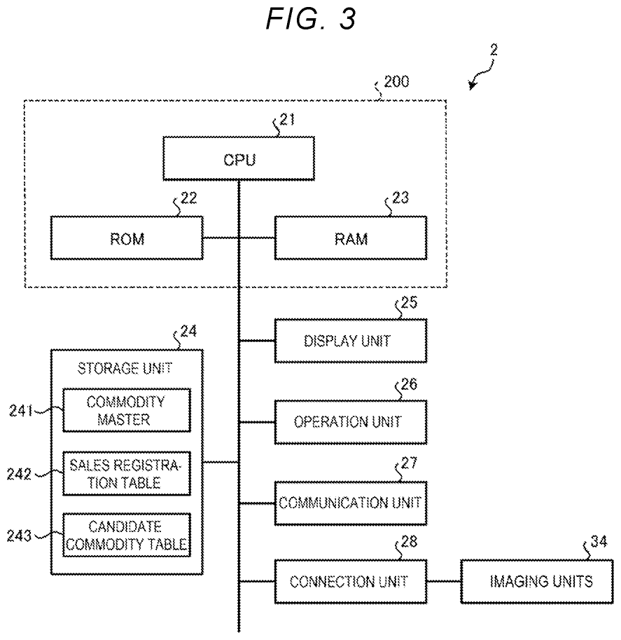

Here, a hardware configuration of the tablet terminal 2 will be described. FIG. 3 is a diagram showing an example of the hardware configuration of the tablet terminal 2.

As shown in FIG. 3, the tablet terminal 2 includes a central processing unit (CPU) 21, a read only memory (ROM) 22, a random access memory (RAM) 23, a storage unit 24, a display unit 25, an operation unit 26, a communication unit 27, a connection unit 28, and the like.

The CPU 21 is an example of a processor and comprehensively controls an operation of the tablet terminal 2. The ROM 22 stores various programs. The RAM 23 is a workspace in which programs and various kinds of data are loaded.

The CPU 21, the ROM 22, and the RAM 23 are connected via a bus or the like to constitute a control unit 200 having a computer configuration. In the control unit 200, the CPU 21 executes various kinds of processing when the CPU 21 operates in accordance with programs stored in the ROM 22 or the storage unit 24 and loaded in the RAM 23.

The storage unit 24 includes a storage medium such as a hard disk drive (HDD) or a flash memory, and maintains storage contents even when a power supply of the storage unit 24 is cut off. The storage unit 24 stores programs that are executed by the CPU 21 and various kinds of setting information. The storage unit 24 stores a commodity master 241, a sales registration table 242, a candidate commodity table 243, and the like.

The commodity master 241 is a data table for managing commodities to be sold in a store. The sales registration table 242 is an example of the first registration information. The sales registration table 242 is a data table for managing registered commodities. The candidate commodity table 243 is an example of the second registration information. The candidate commodity table 243 is a data table for managing commodities that are candidates for sales registration.

The display unit 25 is a display device such as a liquid crystal display (LCD). The display unit 25 displays various kinds of information under the control of the CPU 21. The operation unit 26 is an input device that includes, for example, a keyboard and a pointer. The operation unit 26 outputs operation information, which is input via the operation unit 26, to the CPU 21. The operation unit 26 may be a touch panel provided on the display unit 25.

The communication unit 27 is a wired or wireless communication interface that is connected to the network Nb. The communication unit 27 is communicably connected to the wireless access point 7 via the network Nb. The control unit 200 communicates with the server 4 and the payment machines 8 via the communication unit 27.

The connection unit 28 is an interface for connecting the tablet terminal 2 to peripheral devices. The connection unit 28 is a wired or wireless interface conforming to standards such as a universal serial bus (USB) and a Bluetooth®. In the present embodiment, the connection unit 28 is connected to the imaging units 34.

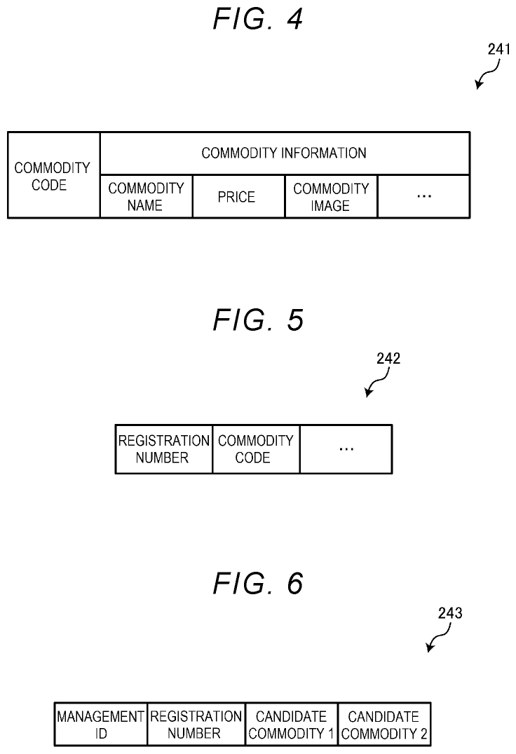

FIG. 4 is a diagram showing an example of a data configuration of the commodity master 241. As shown in FIG. 4, the commodity master 241 stores a commodity code and commodity information in correlation with each other. The commodity code is an example of identification information by which the types of commodities to be sold in the store can be identified. As the commodity code, for example, a Japanese Article Numbering (JAN) code or the like can be used. The commodity information is information on a commodity corresponding to a commodity code. For example, a commodity name, a price, a commodity image, and the like are stored in the commodity information. Here, the commodity name is information indicating at least a product name of a commodity. The price is information indicating a unit price of a commodity. The commodity image is image information representing an appearance or the like of a commodity.

The data configuration of the commodity master 241 is not limited to that shown in FIG. 4. For example, feature information indicating an appearance of a commodity corresponding to the commodity code may be stored in correlation with the commodity code. Such feature information can be used as matching information when a commodity is to be recognized from an image. The feature information may be the above-described commodity image, or may be information quantitatively indicating an appearance feature of a commodity.

The tablet terminal 2 stores the commodity master 241 in the present embodiment. The server 4 may also hold the commodity master 241. In this case, each tablet terminal 2 can manage, by referring to the commodity master 241 held by the server 4, the commodity master 241 in the same manner as in the case of being locally stored.

FIG. 5 is a diagram showing an example of a data configuration of the sales registration table 242. As shown in FIG. 5, the sales registration table 242 stores a registration number and a commodity code in correlation with each other. The registration number is information indicating an order in which the sales registration is performed. The commodity code is a commodity code of a registered commodity and corresponds to the commodity code in the commodity master 241.

Specifically, when the same type of commodity (same commodity code) is specified from images captured by the imaging units 34, the commodity code of the commodity is stored in the sales registration table 242 in correlation with a newly generated registration number. As will be described later, when there is a plurality of types of commodities (plurality of commodity codes) specified from the images captured by the imaging units 34, the different commodity codes are stored in the candidate commodity table 243 without any of the different commodity codes being stored in the sales registration table 242. However, in the present embodiment, in order to maintain a sales registration order of registered commodities and candidate commodities, a registration number is newly generated and stored in the sales registration table 242 even when there is a plurality of types of commodities specified from the images captured by the imaging units 34.

The data configuration of the sales registration table 242 is not limited to that shown in FIG. 5. For example, in the sales registration table 242, commodity information corresponding to a commodity code may be stored in correlation with the commodity code. Date and time information indicating the date and time when the sales registration is performed may also be stored in correlation with the commodity code.

FIG. 6 is a diagram showing an example of a data configuration of the candidate commodity table 243. As shown in FIG. 6, the candidate commodity table 243 stores a management ID, a registration number, and candidate commodities (candidate commodities 1 and 2) in correlation with one another. The management ID is identification information for managing data stored in the candidate commodity table 243. The registration number is a number related to the sales registration for the commodity managed by the management ID, and corresponds to the registration number in the sales registration table 242. In the candidate commodity columns, commodity codes of commodities that are candidates for sales registration are stored.

In the present embodiment, two storage areas for candidate commodities (candidate commodities 1 and 2) are provided so that commodity codes of commodities specified from images captured by the imaging units 341 and 342 can be stored. The number of the storage areas is not limited thereto.

The tablet terminal 2 stores the sales registration table 242 and the candidate commodity table 243 in the present embodiment. The server 4 may also hold the sales registration table 242 and the candidate commodity table 243. In this case, the server 4 manages the sales registration table 242 and the candidate commodity table 243 for each transaction by generating a transaction ID by which each transaction performed in each tablet terminal 2 can be identified and storing the sales registration table 242 and the candidate commodity table 243 in correlation with the transaction ID.

Specifically, the server 4 notifies a tablet terminal 2 of the generated transaction ID for the transaction ID to be stored in the tablet terminal 2 while the transaction corresponding to the transaction ID is performed. Then, the tablet terminal 2 transmits the commodity code of the commodity that is a sales registration target to the server 4 together with the transaction ID, and instructs the server 4 to store the commodity code in the sales registration table 242 corresponding to the transaction ID. Accordingly, the server 4 can collectively manage registered commodities in the tablet terminals 2. In addition, the tablet terminal 2 transmits a commodity code of a candidate commodity together with a transaction ID to the server 4, and instructs the server 4 to store the commodity code in the candidate commodity table 243 corresponding to the transaction ID. Accordingly, the server 4 can collectively manage commodities that are candidates for sales registration in the tablet terminals 2. It is assumed that each tablet terminal 2 can refer to the sales registration table 242 and the candidate commodity table 243 for a transaction related to the tablet terminal 2.

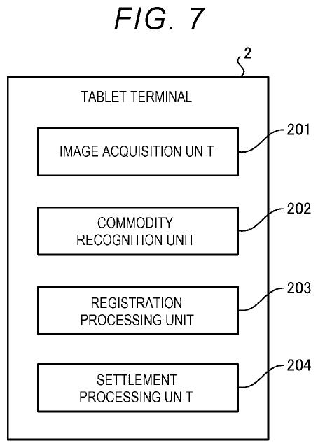

Next, a functional configuration of the tablet terminal 2 will be described. FIG. 7 is a diagram showing an example of the functional configuration of the tablet terminal 2.

As shown in FIG. 7, the tablet terminal 2 includes an image acquisition unit 201, a commodity recognition unit 202, a registration processing unit 203, and a settlement processing unit 204 as the functional configuration.

The functional configuration of the tablet terminal 2 may be a software configuration implemented by the CPU 21 in the tablet terminal 2 operating in accordance with a program stored in the ROM 22 or the storage unit 24, but is not limited to the software configuration. For example, a part or all of the functional configuration of the tablet terminal 2 may be in a form implemented by hardware such as dedicated circuits.

The image acquisition unit 201 acquires, via the connection unit 28, an image captured by an imaging unit 34. The commodity recognition unit 202 is an example of a specifying unit. The commodity recognition unit 202 specifies, based on the image acquired by the image acquisition unit 201, the commodity whose image is captured by the imaging unit 34. Specifically, the commodity recognition unit 202 recognizes a commodity from the image captured by the imaging unit 34 by using a known object recognition technique or the like, and specifies a type of the commodity, that is, a commodity code based on an appearance feature or the like of the recognized commodity.

Specifically, the commodity recognition unit 202 recognizes a commodity to be stored in the housing unit 31 from images captured by the imaging units 341 and 342 at the same time. The commodity recognition unit 202 may decode a code symbol attached to a commodity to specify a commodity code held in the code symbol.

The recognition accuracy of the commodity recognition unit 202 for a commodity is not 100%, and recognition results (hereinafter, also referred to as specification results) may be different depending on an imaging condition or the like of the commodity. For example, even if commodities to be recognized are the same, conditions such as an angle for photographing a commodity by the imaging unit 341 and the imaging unit 342 are different, and thus the specification results of commodities may be different between an image captured by the imaging unit 341 and an image captured by the imaging unit 342. In such a case, the commodity recognition unit 202 specifies two different commodity codes from the images captured by the imaging unit 341 and the imaging unit 342.

The registration processing unit 203 is an example of a registration unit, a display control unit, and a reception unit. The registration processing unit 203 executes sales registration processing of the commodity specified by the commodity recognition unit 202. Specifically, the registration processing unit 203 stores, in the sales registration table 242 in correlation with a registration number, a commodity code of the commodity specified by the commodity recognition unit 202. When the registration processing unit 203 reads a commodity name and price corresponding to the commodity code from the commodity master 241, the registration processing unit 203 adds the commodity to a list of registered commodities, which are displayed on the display unit 25 in order by their registration number.

Here, as described above, depending on the processing result of the commodity recognition unit 202, different commodity codes may be specified from the image derived from the imaging unit 341 and the image derived from the imaging unit 342. In this case, the registration processing unit 203 stores, as candidate commodities in the candidate commodity table 243, different commodity codes specified by the commodity recognition unit 202. More specifically, the registration processing unit 203 records an order of the sales registration by storing a registration number in the sales registration table 242, and then stores, in the candidate commodity table 243, the registration number and the different commodity codes (candidate commodities) specified by the commodity recognition unit 202 in correlation with each other.

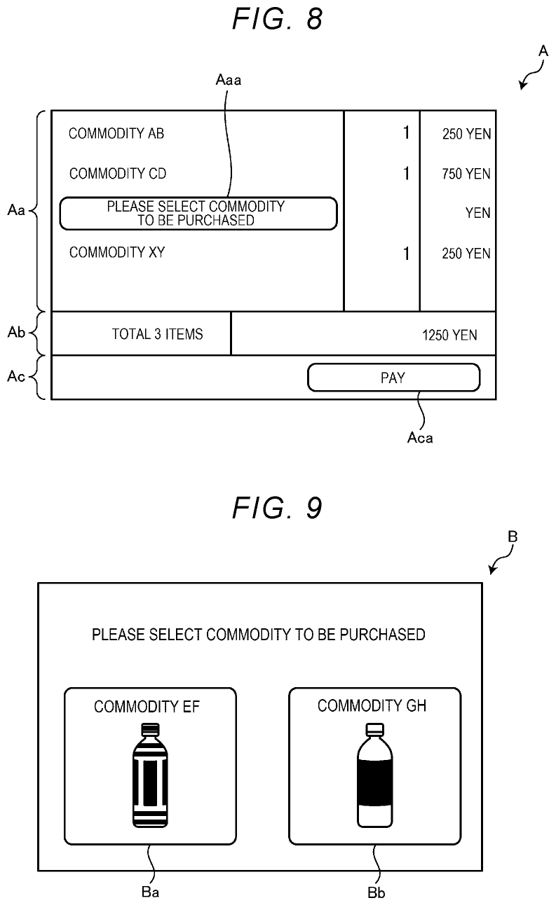

When storing the candidate commodities in the candidate commodity table 243, the registration processing unit 203 displays, on the display unit 25, information notifying that the candidate commodities are present. Here, the notification method is not particularly limited, and for example, the notification may be performed in the manner shown in FIG. 8.

FIG. 8 is a diagram showing an example of a screen A (hereinafter, also referred to as a commodity registration screen) displayed on the tablet terminal 2. As shown in FIG. 8, the commodity registration screen A includes a commodity display area Aa, a total display area Ab, and an operation area Ac.

The information about the registered commodities such as a commodity name, a quantity, a price, and the like of each of the registered commodities are displayed in a registration order in the commodity display area Aa. Specifically, the registration processing unit 203 displays the commodity name, the quantity, the price, and the like of each of the registered commodities in order by registration number based on the information stored in the commodity master 241 and the sales registration table 242. In addition, based on the registration number stored in the candidate commodity table 243, the registration processing unit 203 displays an operation element Aaa by which a message for prompting selection of a commodity is added to commodity display area Aa.

Here, the operation element Aaa is an example of information for notifying that the candidate commodities are present. In addition, a registration number (or a management ID) is correlated with the operation element Aaa, and when the operation element Aaa is selected, the registration processing unit 203 displays, for example, a screen shown in FIG. 9 on the display unit 25 based on the registration number (or the management ID) of the operation element Aaa.

FIG. 9 is a diagram showing an example of the screen B (hereinafter, also referred to as a commodity selection screen) displayed on the tablet terminal 2. As shown in FIG. 9, a commodity selection screen B includes a first display area Ba and a second display area Bb for displaying candidate commodities.

Specifically, when the operation element Aaa is selected, the registration processing unit 203 reads, based on the registration numbers (or the management IDs) correlated with the operation element Aaa, the commodity codes registered as the candidate commodities from the candidate commodity table 243. Then, the registration processing unit 203 displays, based on the information stored in the commodity master 241, the commodity names, the commodity images, and the like corresponding to the commodity codes read as the candidate commodities in the first display area Ba and the second display area Bb. FIG. 9 shows an example in which a “commodity EF” is displayed in the first display area Ba and a “commodity GH” is displayed in the second display area Bb.

Here, the first display area Ba and the second display area Bb also function as operation elements, and when either one of the commodities is selected by the customer, the registration processing unit 203 stores a commodity code of a candidate commodity corresponding to the selected display area in the sales registration table 242. More specifically, the registration processing unit 203 stores the commodity code of the candidate commodity corresponding to the selected display area in the sales registration table 242 in correlation with the corresponding registration number. The registration processing unit 203 deletes, from the candidate commodity table 243, the data entry related to the corresponding registration number. Then, the registration processing unit 203 deletes the commodity selection screen B and returns the display to the commodity registration screen A.

For example, when the “commodity EF” is selected on the commodity selection screen B in FIG. 9, the registration processing unit 203 displays the commodity name (commodity EF), the quantity, the price, and the like of the registered commodity EF instead of the operation element Aaa in the commodity display area Aa as shown in the commodity registration screen A in FIG. 10. Here, FIG. 10 is a diagram showing an example of a screen displayed on the display unit 25 of the tablet terminal 2.

The sales registration for a new commodity can be performed based on the examples of the commodity registration screen A in both FIGS. 8 and 10. That is, in the tablet terminal 2 according to the present embodiment, a new commodity can be stored in the sales registration table 242 even when a candidate commodity is stored in the candidate commodity table 243.

As described above, in the tablet terminal 2, the sales registration operation can continue being performed for new commodities even when the specification results for a previous commodity based on multiple captured images are different. In the tablet terminal 2, a selection operation for a commodity stored as a candidate commodity in the candidate commodity table 243 can be performed at any time, which is more convenient to a customer than stopping the sales registration operation for new commodities until the selection operation for the candidate commodity is performed.

Description of the commodity registration screen A will be continued. The total quantity of registered commodities (items) and the total purchase price of the registered commodities are displayed in the total display area Ab. Specifically, the registration processing unit 203 calculates a total quantity and a total price based on the prices and quantities of each of the registered commodities, and displays the total quantity and the total price in the total display area Ab. As shown in FIG. 8, the quantities and prices of candidate commodities are excluded when calculating the total quantity and total price.

Various operation buttons are displayed in the operation area Ac. For example, a payment button Aca is displayed in the operation area Ac. The payment button Aca is an operation element for ending the sales registration for commodities and instructing payment for the commodities stored in the sales registration table 242.

When the payment button Aca is selected, the registration processing unit 203 determines the commodities stored in the sales registration table 242 as the registered commodities for one transaction by ending the processing related to the commodity registration if the candidate commodity table 243 is empty. Here, when the candidate commodity table 243 is not empty, that is, when candidate commodities are stored, the registration processing unit 203 notifies presence of an undetermined commodity and displays a screen for selecting a sales registration target commodity from the candidate commodities. For example, the registration processing unit 203 prompts the customer to select a commodity to be purchased, by sequentially displaying for each entry of the candidate commodity table 243, the commodity selection screen B shown in FIG. 9 in order by management ID (or registration number). Then, when the candidate commodity table 243 becomes empty, the registration processing unit 203 ends the processing related to the commodity registration and determines the commodities stored in the sales registration table 242 as the registered commodities for one transaction. After selecting the payment button Aca, the customer moves the shopping cart 3 to the payment machine 8, and the customer pays for the commodities for one transaction.

As described above, the registration processing unit 203 inhibits the payment and continues the sales registration processing until the candidate commodity table 243 becomes empty. Accordingly, the customer performs the selection operation on each of the candidate commodities stored in the candidate commodity table 243 at any time before payment. For example, the customer can process a plurality of candidate commodities at a time immediately before payment, or can process any candidate commodity in the middle of registering commodities during a sales registration operation. Accordingly, a degree of freedom for performing sales registration is provided by the system 1 according to the present embodiment.

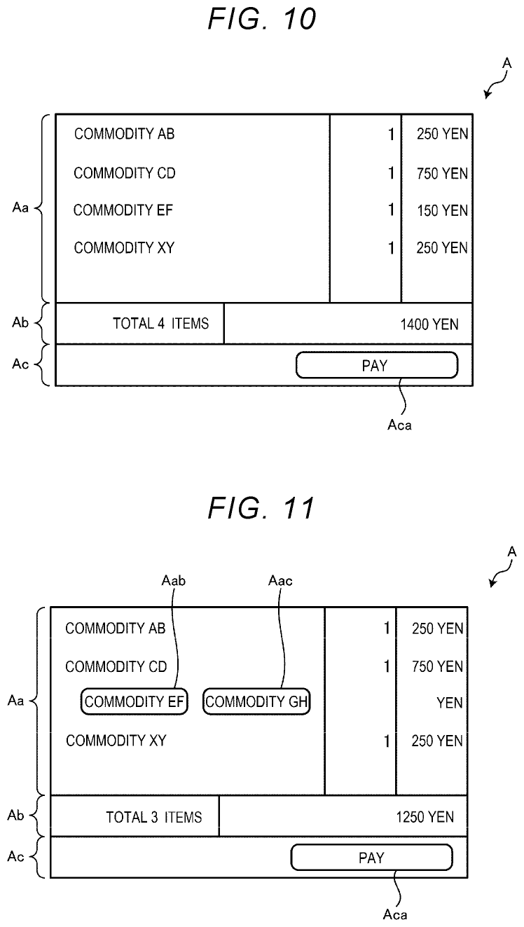

In the above-described example, after the operation element Aaa on the commodity registration screen A is selected, the commodity selection screen B is used to select the sales registration target commodity from the candidate commodities, but such selection is not limited thereto. For example, as shown in FIG. 11, the selection operation for the candidate commodity may be performed in the commodity registration screen A by displaying, on the commodity registration screen A, operation elements corresponding to the first display area Ba and the second display area Bb from the commodity selection screen B.

FIG. 11 is a diagram showing an example of a screen displayed on the tablet terminal 2, and shows another display form of the commodity registration screen A.

The commodity registration screen A shown in FIG. 11 shows an example in which the operation element Aaa from FIG. 8 is replaced with operation elements Aab and Aac in which the commodity names are presented. Here, the operation elements Aab and Aac are operation elements corresponding to the first display area Ba and the second display area Bb on the commodity selection screen B, respectively, and commodity names or the like corresponding to commodity codes of candidate commodities are displayed thereon.

In the commodity registration screen A shown in FIG. 11, a commodity to be purchased can be designated by selecting either one of the operation elements Aab and Aac. Specifically, when either one of the operation elements Aab and Aac is selected, the registration processing unit 203 stores a commodity code of a candidate commodity corresponding to the selected operation element in the sales registration table 242 by the same operation as that in the commodity selection screen B.

Accordingly, the customer can view the registered commodities and the candidate commodities and can select the sales registration target commodity from the displayed candidate commodities by viewing a single commodity registration screen A. Accordingly, the convenience for the selection operation for a candidate commodity can be improved in the tablet terminal 2.

Referring back to FIG. 7, the settlement processing unit 204 executes processing related to settlement of registered commodities in response to the operation of the customer. For example, after selection of the above-described payment button Aca, the settlement processing unit 204 manages payment for the commodities registered in the sales registration table 242.

Specifically, the settlement processing unit 204 enables payment to be performed with one of the payment machines 8, by inputting, to the payment machine 8, data about the registered commodities. For example, the settlement processing unit 204 may encode the sales registration data from the sales registration table 242 into a code symbol such as a two-dimensional code and display the code symbol on the display unit 25. In this case, the payment machine 8 acquires the sales registration data by reading the code symbol displayed on the display unit 25 of the tablet terminal 2, and executes payment processing for the registered commodities for one transaction based on the acquired sales registration data.

For example, the settlement processing unit 204 may transmit sales registration data stored in the sales registration table 242 to the payment machine 8 by near field communication such as Bluetooth®. In this case, the payment machine 8 acquires the sales registration data transmitted from the tablet terminal 2, and executes, based on the acquired sales registration data, the payment processing for the registered commodities for one transaction.

For example, in the case of a configuration in which the sales registration table 242 is stored in the server 4, the settlement processing unit 204 encodes a transaction ID of the transaction into a code symbol such as a one-dimensional bar code or a two-dimensional code and displays the code symbol on the display unit 25. In this case, the payment machine 8 acquires the transaction ID by reading the code symbol displayed on the display unit 25 of the tablet terminal 2. Then, the payment machine 8 acquires the sales registration data related to the acquired transaction ID from the server 4, and executes the payment processing for the registered commodities for one transaction based on the acquired sales registration data.

The settlement of the commodity is not limited to the method in which the payment machine 8 is used, and may be performed by the tablet terminal 2. For example, if the settlement processing unit 204 receives, via the operation unit 26, an operation instructing the start of the settlement, the settlement processing unit 204 displays, on the display unit 25, a screen by which a settlement method such as electronic money settlement and credit settlement can be selected. Once a settlement method is selected, the settlement processing unit 204 receives an input of settlement information for performing the settlement by the selected settlement method, and cooperates with an external settlement server to execute, based on the input settlement information, settlement processing for a total price of the registered commodities. The settlement information may be, for example, a credit card number or a two-dimensional code for code settlement. In the case of a two-dimensional code for the code settlement, an input may be received via one of the imaging units 34.

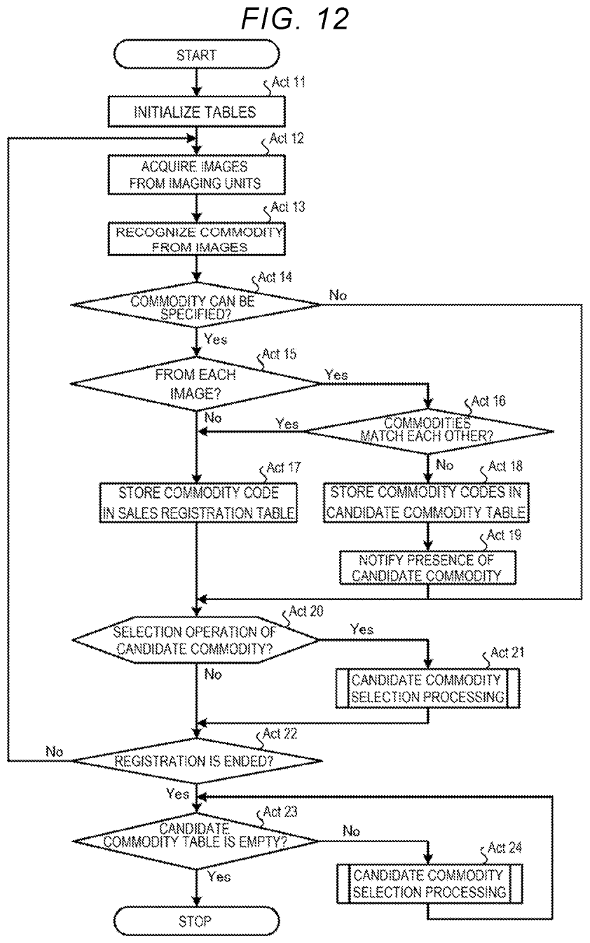

Hereinafter, an operation example of the tablet terminal 2 will be described with reference to FIG. 12. FIG. 12 is a flowchart showing an example of commodity registration processing performed by the tablet terminal 2.

First, the control unit 200 of the tablet terminal 2 starts the present processing in response to an operation via the operation unit 26, and the control unit 200 initializes the sales registration table 242 and the candidate commodity table 243 (Act 11).

When the server 4 is to store the sales registration table 242 and the candidate commodity table 243, the control unit 200 causes the server 4 to store the sales registration table 242 and the candidate commodity table 243 related to a transaction ID of the transaction by requesting generation of the transaction ID by the server 4. The control unit 200 acquires the generated transaction ID from the server 4 and store the transaction ID in the RAM 23 or the like.

Subsequently, the image acquisition unit 201 acquires images from the imaging units 34 (from each of the imaging units 341 and 342) (Act 12). Next, the commodity recognition unit 202 executes processing of recognizing a commodity from the images acquired in Act 12 (Act 13). Next, the registration processing unit 203 determines whether a commodity can be specified (i.e., identified) based on at least one of the images captured by the imaging units 34 (Act 14). Here, if no commodity can be specified (Act 14; No), the processing of FIG. 12 proceeds to Act 20.

If it is determined that a commodity can be specified based on at least one of the images (Act 14; Yes), the registration processing unit 203 determines whether a commodity is specified for each of the images (Act 15). If a commodity is only specified from the image captured by one of the imaging units 341 and 342 (Act 15; No), the registration processing unit 203 stores a commodity code of the specified commodity in the sales registration table 242 (Act 17), and the processing of FIG. 12 proceeds to Act 20.

If a commodity is specified from the image captured by each of the imaging unit 341 and the imaging unit 342 (Act 15; Yes), the registration processing unit 203 determines whether the specified commodities match each other (Act 16). Here, if the specified commodities match each other (Act 16; Yes), that is, if there is a single type of specified commodity, the registration processing unit 203 stores the commodity code of the specified commodity in the sales registration table 242 (Act 17), and proceeds to Act 20.

In addition, if it is determined that the specified commodities do not match each other (Act 16; No), that is, if there is a plurality of types of specified commodities, the registration processing unit 203 stores a commodity code of each of the commodities as a plurality of candidate commodities in the candidate commodity table 243 (Act 18). Next, the registration processing unit 203 notifies the presence of the candidate commodities by, for example, displaying the operation element Aaa and the like on the above-described commodity registration screen A (Act 19), and proceeds to Act 20.

Subsequently, the registration processing unit 203 determines whether a selection operation of selecting a sales registration target commodity from candidate commodities is received (Act 20). For example, the registration processing unit 203 determines whether the operation element Aaa on the commodity registration screen A is selected.

Here, if the selection operation is not received (Act 20; No), the processing of FIG. 12 proceeds to Act 22. If it is determined that the selection operation is received (Act 20; Yes), the registration processing unit 203 executes candidate commodity selection processing (Act 21), and proceeds to Act 22. The candidate commodity selection processing will be described later.

Subsequently, the registration processing unit 203 determines whether an operation of ending the sales registration is performed (Act 22). For example, the registration processing unit 203 determines whether the payment button Aca on the commodity registration screen A is selected.

Here, if the ending operation is not performed (Act 22; No), the registration processing unit 203 returns to Act 12 to continue the sales registration. If it is determined that the ending operation is performed (Act 22; Yes), the registration processing unit 203 determines whether the candidate commodity table 243 is empty (Act 23). Here, if candidate commodities are currently stored in the candidate commodity table 243 (Act 23; No), the registration processing unit 203 executes candidate commodity selection processing (Act 24) and returns to Act 23.

On the other hand, if it is determined that the candidate commodity table 243 is empty (Act 23; Yes), the registration processing unit 203 determines commodities stored in the sales registration table 242 as the registered commodities for one transaction, and ends the present processing.

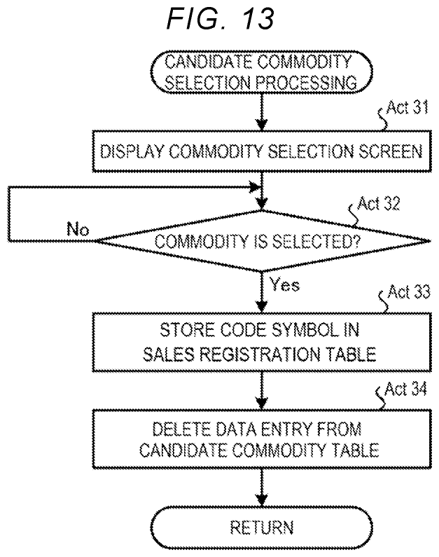

Next, the candidate commodity selection processing performed by the tablet terminal 2 will be described with reference to FIG. 13. FIG. 13 is a flowchart showing an example of the candidate commodity selection processing performed by the tablet terminal 2. In the present processing, a form in which a sales registration target commodity is selected using the commodity selection screen B will be described.

First, the registration processing unit 203 displays the commodity selection screen B on the display unit 25 based on the candidate commodities stored in the candidate commodity table 243 (Act 31).

For example, if a registration number is designated by the operation element Aaa, the registration processing unit 203 displays, on the display unit 25, the commodity selection screen B of candidate commodities related to the designated registration number. If a registration number is not designated, for example, if the payment button Aca is selected while there are still candidate commodities stored in the candidate commodity table 243, the registration processing unit 203 sets the candidate commodities to be displayed in an ascending order of their management IDs (or registration numbers), and displays the commodity selection screen B for the candidate commodities on the display unit 25.

Subsequently, the registration processing unit 203 waits while a sales registration target commodity is not yet selected from the candidate commodities (Act 32; No). Once the sales registration target commodity is selected (Act 32; Yes), the registration processing unit 203 stores a code symbol of the selected commodity in the sales registration table 242 (Act 33). Next, the registration processing unit 203 deletes a data entry related to the commodity registered in Act 33 from the candidate commodity table 243 (Act 34), and returns to the commodity registration processing in FIG. 12.

As described above, the system 1 according to the present embodiment includes: the imaging units 34 configured to capture images of a commodity that is a purchase target to be stored in the housing unit; the commodity recognition unit 202 configured to recognize a commodity from the images captured by the imaging units 34 and specify, based on the recognition result, a type of the commodity to be stored in the housing unit; and the registration processing unit 203 configured to, when there is a single type of commodity specified, store the type of commodity as a commodity that is a purchase target in the sales registration table 242, and when there is a plurality of types of commodities specified, store a set of the types of commodities as candidate commodities in the candidate commodity table 243. The registration processing unit 203 receives a selection of one commodity from the candidate commodities stored in the candidate commodity table 243 and stores a commodity code of the selected commodity in the sales registration table 242.

Accordingly, in the system 1 according to the present embodiment, even when the types of commodities specified from the captured images of the same commodity are different, there is no need to confirm a correct commodity before registering new commodities. In the system 1 according to the present embodiment, the selection operation for a candidate commodity in the candidate commodity table 243 can be performed at any time before the sales registration for an entire transaction is ended. Accordingly, the system 1 according to the present embodiment efficiently performs the sales registration of commodities. In the system 1 according to the present embodiment, convenience for performing the sales registration of commodities is thus improved.

The above-described embodiment can be appropriately modified and implemented by changing configurations or functions of the above-described devices. Hereinafter, some modifications according to the above-described embodiment will be described as other embodiments. Hereinafter, points different from the above-described embodiment will primarily be described, and detailed description of points in common with the above-described embodiment will be omitted. The modifications described below may be implemented individually or may be implemented in combination as appropriate.

### Modification 1

The number of the imaging units 34 attached to the shopping cart 3 is plural, but is not limited thereto. A single imaging unit 34 may be provided. In this case, the commodity recognition unit 202 performs different types (methods) of recognition processing on an image captured by the single imaging unit 34 and outputs a specification result of the commodity for each type of recognition processing.

For example, the commodity recognition unit 202 may perform, on the image captured by the single imaging unit 34, first recognition processing of reading a code symbol and second recognition processing of general object recognition. Then, the commodity recognition unit 202 outputs the specification results of the first recognition processing and the second recognition processing.

In addition, the registration processing unit 203 performs the same processing as in the above-described embodiment based on the specification results output by the commodity recognition unit 202. Accordingly, in the tablet terminal 2 according to the present modification, the same effect as that of the above-described embodiment can be achieved even when the single imaging unit 34 is used.

### Modification 2

In an embodiment, the matching determination of the specification results concerns a commodity being placed (stored) in the housing unit 31, but there is no limitation in this regard. The matching determination for the commodity may also or instead be performed when the commodity is picked up (removed) from the housing unit 31.

Specifically, when the commodity recognition unit 202 recognizes a commodity, the commodity recognition unit 202 detects a movement direction of the commodity from a series of images of the commodity that are captured in a short period of time. Specifically, the commodity recognition unit 202 detects a motion (for example, a motion vector) for the commodity relative to the housing unit 31. That is, the commodity recognition unit 202 detects information by which it can be determined whether the commodity is being placed into the housing unit 31 or the commodity is being picked up from the housing unit 31. It is assumed that the commodity recognition unit 202 specifies a commodity code once per imaging unit 34 for a series of images captured thereby.

When the commodity recognition unit 202 recognizes the commodity and also detects that the commodity has been moved downward, the registration processing unit 203 determines that the commodity has been placed in the housing unit 31. In this case, the registration processing unit 203 stores a commodity code of the commodity, specified by the commodity recognition unit 202, in the sales registration table 242 or in the candidate commodity table 243 in correlation with a registration number.

When the commodity recognition unit 202 recognizes the commodity and also detects that the commodity has been moved upward, the registration processing unit 203 determines that the commodity has been picked up from the housing unit 31.

When it is determined that the commodity has been picked up from the housing unit 31, the registration processing unit 203 performs matching determination for the commodity codes specified by the commodity recognition unit 202. Then, if it is determined that the specified commodity codes for the item being picked up do not match each other, the registration processing unit 203 displays, on the display unit 25, a screen by which the commodity to be purchased or cancelled (removed from the registered commodities) can be selected as in the above-described embodiment.

When a commodity is picked up from the housing unit 31, the commodity code of the commodity should already be stored in the sales registration table 242 or the candidate commodity table 243. The registration processing unit 203 does not perform a new registration but instead deletes the associated data entry so the picked up item is no longer registered for purchase.

Specifically, if the commodity codes specified by the commodity recognition unit 202 all match each other, the registration processing unit 203 deletes the data entry including this commodity code from the sales registration table 242 or the candidate commodity table 243. If the commodity code of the specified commodity is in both the sales registration table 242 and the candidate commodity table 243, it may be preferable that the registration processing unit 203 deletes the data entry from the sales registration table 242 unless other user confirmation or the like regarding the commodity is received.

If the commodity codes of the picked up commodity as specified by the commodity recognition unit 202 do not match each other, the registration processing unit 203 displays, on the display unit 25, a screen (for example, the commodity selection screen B) by which a commodity corresponding to one of the commodity codes can be selected. Then, upon selection of the commodity, the registration processing unit 203 deletes the data entry matching the commodity code of the selected commodity from the sales registration table 242 or the candidate commodity table 243. In this case, the commodity that is to be deleted (cancelled) from the registered commodities (a deletion target) will be a commodity already stored in the sales registration table 242 or the candidate commodity table 243, and thus, when the commodity recognition unit 202 specifies a commodity that is not one already registered for purchase or at least as a candidate for purchase, the specified commodity may simply be excluded from the potential matching determination targets.

If the commodity specification results do not match each other when a commodity is picked up from the housing unit 31, it is preferable to immediately display the commodity selection screen B. However, the commodity selection screen B may be displayed at any time as in the above-described embodiment.

In this case, for example, the commodity codes of the already registered commodities may be stored in the candidate commodity table 243 as the candidate commodities that might be canceled/deleted from the already registered commodities by the user's removal from the housing unit 31, and a candidate commodity may be selected at any time. As an example, whether a commodity being moved by a user is a sales registration candidate commodity or a deletion target candidate commodity may be identifiable using flag information or the like. In this case, in order to prevent a registration deletion (cancelation of an already registered item) from being performed after sales registration for the same commodity, it may be preferable to request the selection of the candidate commodity to be canceled/deleted before proceeding to the selection of a sales registration candidate commodity.

### Modification 3

The an embodiment describes that the commodity is placed in the housing unit 31 of the shopping cart 3, but there is no limitation on this example. A commodity may be placed in a housing unit of another form. For example, a shopping basket or the like used when transporting a commodity in a store can also be an example of the housing unit 31. In this case, the imaging units 34 are disposed at an edge of an opening of the shopping basket, and are disposed such that an inside of the shopping basket is included in at least a part of the imaging areas of the imaging units 34.

In this case, a mobile terminal such as a smartphone having the same function as that of the tablet terminal 2 may be used instead of the tablet terminal 2. The shopping basket may be carried around by a customer, or may be moved after being placed in the housing unit 31 of the shopping cart 3.

### Modification 4

The tablet terminal 2 recognizes (and specifies) a commodity from the image captured by the imaging units 34 in the above-described embodiment, but there is no limitation on this example. An external device such as the server 4 may recognize (and specify) the commodity. For example, the server 4 may include the commodity recognition unit 202. In this case, the image acquisition unit 201 of the tablet terminal 2 transmits acquired images to the server 4. The commodity recognition unit 202 of the server 4 may recognize (and specify) a commodity from the images transmitted from the tablet terminal 2 and return a processing result thereof to the tablet terminal 2.

The registration processing unit 203 of the tablet terminal 2 displays the above-described commodity registration screen A or the above-described commodity selection screen B on the display unit 25 based on the processing result returned from the server 4. Then, the registration processing unit 203 of the tablet terminal 2 stores a commodity code of a commodity selected from candidate commodities via the display unit 25 in the sales registration table 242 or deletes a data entry related to the commodity code from the candidate commodity table 243.

### Modification 5

The sales registration table 242 and the candidate commodity table 243 are separate tables in the above-described embodiment, but there is no limitation on this example. The candidate commodities may be managed by using only the sales registration table 242.

In this case, when there is a plurality of types of commodities specified by the commodity recognition unit 202, the registration processing unit 203 stores commodity codes of the commodities in the sales registration table 242. In addition, the registration processing unit 203 processes commodities for which a plurality of different commodity codes are registered relative to one registration number as candidate commodities, and executes processing of prompting selection as in the above-described embodiment. Specifically, when the sales registration target commodity is selected from the candidate commodities, the registration processing unit 203 deletes, from the sales registration table 242, a commodity code of another commodity registered in correlation with the same registration number as the selected commodity.

In the case of the present modification, the first registration information and the second registration information are both the sales registration table 242.

The programs executed by the devices in the above-described embodiment (and modifications) are stored in advance in a ROM, in a storage device such as an HDD or flash memory, or the like. The programs executed by the devices in the above-described embodiment may be recorded in a computer-readable recording medium such as a CD-ROM, a flexible disk (FD), a CD-R, or a digital versatile disk (DVD) as a file in an installable or executable format.

Furthermore, the programs executed by the devices in the above-described embodiment may be stored in a computer connected to a network such as the Internet and downloaded via the network. The programs executed by the devices in the above-described embodiment may be distributed across a network such as the Internet.

While embodiments have been described, the embodiments have been presented by way of example and are not intended to limit the scope of the disclosure. These novel embodiments and modifications can be implemented in various other forms, and various omissions, replacements, changes, and combinations can be made without departing from the invention. The embodiments and the modifications thereof are included in the scope of the disclosure, and are included in the scope of the claims and equivalents thereof.

What is claimed is:

1. A commodity registration system, comprising:
a camera; and
a commodity registration device including a processor configured to:
acquire images of a commodity being placed in a housing unit from the camera;
determine, based on at least one of the acquired images, commodity type identifications for the commodity; and
when the commodity type identifications are different:
store each of the commodity type identifications in second registration information, the second registration information identifying candidates for commodities to be purchased; and
in response to a user selection of one of the commodity type identifications stored in the second registration information, store the selected commodity type identification in first registration information, the first registration information identifying commodities to be purchased.

2. The commodity registration system according to claim 1, wherein the processor of the commodity registration device is further configured to:
when the commodity type identifications are different, display a screen showing each of the commodity type identifications stored in the second registration information, in a manner that allows for the user selection of the one of the commodity type identifications, and wherein
the user selection of the one of the commodity type identifications is made on the displayed screen.

3. The commodity registration system according to claim 2, wherein the screen is displayed in response to receiving a user instruction to end the registration of commodities to purchase as part of a transaction.

4. The commodity registration system according to claim 2, wherein the screen is displayed while each of the commodity type identifications are stored in the second registration information.

5. The commodity registration system according to claim 1, further comprising:
an additional camera, the plurality of cameras being arranged at different locations relative to the housing unit, wherein
the processor of the commodity registration device determines each of the commodity type identifications from an image captured by a different one of the plurality of cameras.

6. The commodity registration system according to claim 1, wherein the processor of the commodity registration device determines the commodity type identifications by applying different recognition processing methods to the at least one acquired image, and one of the different recognition processing methods includes reading a code symbol from the at least one acquired image.

7. The commodity registration system according to claim 1, wherein the processor of the commodity registration device is further configured to:
after storing each of the commodity type identifications in the second registration information, receive a user instruction to end the registration of commodities to purchase as part of a transaction; and
in response to the user instruction, read the second registration information to determine whether the second registration information still includes each of the commodity type identifications.

8. The commodity registration system according to claim 7, wherein the processor of the commodity registration device is further configured to:
in response to the read second registration information still including each of the commodity type identifications, display a screen showing each of the commodity type identifications still stored in the second registration information, in a manner that allows for the selection of the one of the commodity type identifications, and wherein the user selection of the one of the commodity type identifications is made on the displayed screen.

9. The commodity registration system according to claim 7, wherein the processor of the commodity registration device is further configured to:
in response to the read second registration information being empty, determine that all the commodities currently identified by the first registration information are the only commodities to be purchased as part of the transaction.

10. The commodity registration system according to claim 9, wherein the processor of the commodity registration device is further configured to:
perform settlement of the transaction by using one of a credit card number and a two-dimensional code as a payment method for all the commodities currently identified by the first registration information.

11. A commodity registration device, comprising:
a memory; and
a processor configured to:
acquire images of a commodity being placed in a housing unit from a camera;
determine, based on at least one of the acquired images, commodity type identifications for the commodity; and
when the commodity type identifications are different:
store each of the commodity type identifications in second registration information, the second registration information identifying candidates for commodities to be purchased; and
in response to a user selection of one of the commodity type identifications stored in the second registration information, store the selected commodity type identification in first registration information, the first registration information identifying commodities to be purchased.

12. The commodity registration device according to claim 11, wherein the processor is further configured to:
when the commodity type identifications are different, display a screen showing each of the commodity type identifications stored in the second registration information, in a manner that allows for the user selection of the one of the commodity type identifications, and wherein
the user selection of the one of the commodity type identifications is made on the displayed screen.

13. The commodity registration device according to claim 12, wherein the screen is displayed in response to receiving a user instruction to end the registration of commodities to purchase as part of a transaction.

14. The commodity registration device according to claim 12, wherein the screen is displayed while each of the commodity type identifications are stored in the second registration information.

15. The commodity registration device according to claim 11, wherein the processor is further configured to:
determine each of the commodity type identifications from an image captured by a different one of a plurality of cameras, the plurality of cameras being arranged at different locations relative to the housing unit.

16. An information processing method for a commodity registration system, the information processing method comprising:
acquiring images of a commodity being placed in a housing unit from a camera;
determining, based on at least one of the acquired images, commodity type identifications for the commodity; and
when the commodity type identifications are different:
storing each of the commodity type identifications in second registration information, the second registration information identifying candidates for commodities to be purchased; and
in response to a user selection of one of the commodity type identifications stored in the second registration information, storing the selected commodity type identification in first registration information, the first registration information identifying commodities to be purchased.

17. The information processing method according to claim 16, wherein determining the commodity type identifications comprises applying different recognition processing methods to the at least one acquired image, and one of the different recognition processing methods includes reading a code symbol from the at least one acquired image.

18. The information processing method according to claim 16, further comprising:
after storing each of the commodity type identifications in the second registration information, receiving a user instruction to end the registration of commodities to purchase as part of a transaction; and
in response to the user instruction, reading the second registration information to determine whether the second registration information still includes each of the commodity type identifications.

19. The information processing method according to claim 18, further comprising:
in response to the read second registration information still including each of the commodity type identifications, displaying a screen showing each of the commodity type identifications still stored in the second registration information, in a manner that allows for the selection of the one of the commodity type identifications, wherein
the user selection of the one of the commodity type identifications is made on the displayed screen.

20. The information processing method according to claim 18, further comprising:
in response to the read second registration information being empty, determining that all the commodities currently identified by the first registration information are the only commodities to be purchased as part of the transaction; and
performing settlement of the transaction by using one of a credit card number and a two-dimensional code as a payment method for all the commodities currently identified by the first registration information.
